(19) United States
(12) Patent Application Publication
(10) Pub. No.: US 2014/0298766 A1
(43) Pub. Date: Oct. 9, 2014

(54) DRIVE SYSTEM, DESIGNED AS A BELT DRIVE, OF A SELF-PROPELLED HARVESTER

(71) Applicant: CLAAS SELBSTFAHRENDE ERNTEMASCHINEN GMBH, HARSEWINKEL (DE)

(72) Inventor: Jan Furmaniak, MUENSTER (DE)

(73) Assignee: CLAAS SELBSTFAHRENDE ERNTEMASCHINEN GMBH, HARSEWINKEL (DE)

(21) Appl. No.: 14/246,378

(22) Filed: Apr. 7, 2014

(30) Foreign Application Priority Data
Apr. 8, 2013 (DE) 10 2013 103 450.0

(51) Int. Cl. A01D 69/00; A01F 12/44

(52) U.S. Cl. CPC A01D 69/00; A01D 69/002; A01F 12/44
USPC 56/14.6

(57) ABSTRACT

A drive system embodied as belt drives of a self-propelled combine harvester includes, on one machine side of the combine harvester, a main drive pulley. The main drive pulley is driven by an internal combustion engine. Proceeding from the main drive pulley, a device for separating out residual grain and a straw chopper are driven via a first intermediate drive stage. A functionally reliable drive of the device for separating out residual grain, the straw chopper and powerful front harvesting attachments and a high power density combined with limited installation space is ensured by use of the drive system.

### CROSS-REFERENCE TO A RELATED APPLICATION

The invention described and claimed hereinbelow is also described in German Priority Document DE 10 2013 103450.0, filed on Apr. 8, 2013. The German Priority Document, the subject matter of which is incorporated herein by reference, provides the basis for a claim of priority of invention under 35 U.S.C. 119(a)-(d).

### BACKGROUND OF THE INVENTION

The invention relates to a drive system of a self-propelled combine harvester. The drive system of the self-propelled combine harvester is designed as a belt drive and comprises a main drive pulley, which is driven on one machine side of the combine harvester by an internal combustion engine, proceeding from which a device for separating out residual grain and a straw chopper are driven via a first intermediate drive stage.

In the case of harvesting grain or rapeseed using a combine harvester, the crop that is severed close to the ground by a front harvesting attachment designed as a header is picked up and conveyed into a threshing and separating mechanism designed as a feed rake. The threshing and separating mechanism is typically designed as a tangential threshing mechanism, wherein modern combine harvesters having a high crop throughput comprise multi-drum arrangements for reducing grain losses. For example, the crop conveyed by the feed rake is first fed to a preacceleration drum and then to a threshing drum. The threshed kernels, in the case of grain, or the threshed fruit, in the case of rapeseed, are conveyed via a grain pain, sieves of a cleaning unit, and a grain elevator, into a grain tank.

Next, the threshed stalk crop is fed via a straw impeller to a device for separating out residual grain. The latter can be designed as an axial conveyor system or as a number of tray-type shakers. The tray-type shakers are moved in a swinging manner and have straw walker steps and under-walker return pockets, via which the residual grain separated from the straw, together with contaminants, reaches a ribbed return pan. A residual-grain separator designed as an axial conveyor system comprises a rotor which conveys in at least one axial direction, and a separating housing, which radially encloses the rotor. The housing is designed as a sieve in the lower region thereof. The straw emerging from the aforementioned tangential threshing mechanism is fed via the straw impeller to the separating housing, which extends in the longitudinal direction of the combine harvester. The rotor conveys the straw, whereby the residual grain is separated out through the separating grate, from which the straw finally exits at the rear of the combine harvester.

If the combine harvester is used to harvest grain, the straw emerging from the device for separating out residual grain can be chopped up via a straw chopper provided at the rear of the combine harvester. Alternatively the straw is deposited, unchopped, as swath onto the stubble. This makes it possible for the straw (set down in a swath), to then be picked up in a further working procedure by a baler provided with a pick-up. The straw chopper, which comprises a rotor having a plurality of rotating knives and a concave having stationary counter-knives, is engaged and disengaged for this purpose. The straw chopper is swivelled out of a working position into a rest position in which the straw can be set down in a swath, as described above.

The header can be replaced by a front harvesting attachment designed as a corn picker. A corn picker comprises intake conveyor elements for the corn plants and snapping rollers disposed downstream thereof. In this case, only the corn cobs and the corn husks are fed to the threshing and separating mechanism. Since the corn stalks must be chopped up for purpose of the subsequent soil management, a chopper is usually provided on the front harvesting attachment. The chopper severs the corn stalks close to the ground and chops them up. It is also possible, however, to provide a combine-mounted straw chopper at the rear of the combine harvester. In contrast to the previously mentioned straw chopper, this combine-mounted straw chopper must be designed to be capable of severing the corn stalks close to the ground.

The rotationally driven mechanisms of combine harvesters are usually connected via belt drives to an output of an internal combustion engine, wherein the belt drives can comprise V-belts or flat belts. Due to the structural dimensions of the combine harvester and the installation position of the internal combustion engine above the mechanism for separating out residual grain, or behind a grain tank, it may be necessary to provide large wheelbases and, therefore, long belt lengths. Due to the limited installation space available for the arrangement of the belt drives and in order to reduce the structural complexity, a few components are driven jointly via one belt drive. Intermediate drive stages are provided in part, which are designed as pulleys configured to accommodate a plurality of drive belts, which are interconnected and are rotatably mounted on a machine frame of the combine harvester. In a relevant intermediate drive stage, one of these pulleys is designed as a driven gear, via which the intermediate drive stage is driven by a belt of an upstream belt drive. At least one further pulley, as the drive gear, drives a belt of a further belt drive. The non-rotatably interconnected pulleys are provided with different diameters in order to create gear ratios.

A few of the belt drives used in such a drive system are used to steplessly change the rotational speed of the corresponding mechanism to be driven and, to this end, are designed as belt variators. It is also possible to design a few of the belt drives to be shiftable or to assign shiftable transmission ratios thereto. Moreover, a ground drive and other drives of the combine harvester, such as the reel, are designed as a steplessly variable, hydrostatic transmission or as a power-split transmission.

Furthermore, there are drive systems in which the mechanisms are driven via universal drive shafts, which extend in the longitudinal direction of the combine harvester. These drive systems, however, are known to have poor efficiency due to the use of angular stages and universal drive shafts. Further disadvantages of this drive via universal drive shafts include the need for a large amount of installation space due to relatively large transmission components, a branched drive design, and limited performance capability.

EP 1 905 291 A1 discloses a drive system designed as a belt drive of a self-propelled combine harvester that comprises a main drive pulley positioned on one machine side of the combine harvester, driven by an internal combustion engine. The drive system comprises three belt transmissions. An element of an intermediate drive stage referred to as a driven pulley is driven by a drive pulley of the internal combustion engine via a first belt transmission. A component of this intermediate drive stage is a drive pulley, which is formed jointly with the aforementioned driven pulley and drives a second belt transmission. In the second belt transmission, a further intermediate drive stage and a driven pulley for a straw chopper are disposed. The latter, third intermediate drive stage drives a third belt transmission, in which a drive pulley for a separating rotor of a device for separating out residual grain is disposed.

### SUMMARY OF THE INVENTION

The present invention overcomes the shortcomings of known arts, such as those mentioned above.

To that end, the present invention provides a drive system designed as a belt drive of a self-propelled combine harvester that ensures a functionally reliable drive for separating out residual grain, the straw chopper, and powerful front harvesting attachments. The inventive drive system obtains a high power density in limited installation space and increases efficiency by a high utilization of the belt.

In an embodiment, the invention provides a drive system embodied as belt drives of a self-propelled combine harvester. The inventive drive system comprises a main drive pulley on one machine side of the combine harvester and is driven by an internal combustion engine. Proceeding from the main drive pulley, a device for separating out residual grain and a straw chopper are driven via a first intermediate drive stage. The main drive pulley, the first intermediate drive stage, and a second intermediate drive stage are intended to be components of a first main belt drive. As such, the first intermediate drive stage directly drives the device for separating out residual grain via a first belt drive and drives the straw chopper via a second belt drive. Furthermore, the second intermediate drive stage is drivably connected to drives of a front harvesting attachment and a cleaning unit.

The power band belt used in the first main belt drive is therefore drivably connected to two intermediate drive stages, which transfer the drive power to the device for separating out residual grain and the straw chopper and to the front harvesting attachment. Due to this power flow, the power band belt used in the first main belt drive can be relatively narrow, since this transfers the drive power to belt engagements of two separate intermediate drive stages. The different power requirement of the front harvesting attachment is also taken into account, which can result from the above-described change from a grain/rapeseed header to a corn picker and/or from a change in the working width of the front harvesting attachment.

Furthermore, the design of the first main belt drive according to the invention results in an ordered basic design, with which a balanced power distribution is obtained and belt stages can be omitted. The first and the second intermediate drive stages are designed as a packet of non-rotatably interconnected pulleys, which is rotatably mounted on the machine frame of the combine harvester. One of the pulleys of the intermediate drive stage is used as a driven pulley, while at least one drive pulley is provided. The at least one drive pulley induces the drive of the front harvesting attachment in the case of the second intermediate drive stage. The first intermediate drive stage, which also comprises a driven gear disposed in the first main belt drive, is connected to the first and the second belt drive via one drive gear in each case. The result thereof is a basic design that forms the basis for an optimal configuration of the further belt drives of the individual mechanisms of the combine harvester.

By contrast, in the drive system according to EP 1 905 291 A1, the entire power flow takes place from the driven pulley of the internal combustion engine to the first intermediate drive stage, via which the drive power is distributed to the intermediate drive stage, which, with the third belt drive, leads to the residual-grain separation, and to the drive of the straw chopper. Therefore, the drive belt must be relatively wide in order to transfer the large drive torque to this intermediate drive stage. For the rest, a drive of the front harvesting attachment is not provided in this drive system.

According to a further embodiment, the main drive belt is drivably connected via a second main belt drive to an auxiliary P.T.O. stub leading to the opposite machine side, via which belt drives on this side of the machine, i.e. on the right side as viewed in the direction of travel, are driven. As a result, the main drive pulley is equipped on the outer circumference thereof with two driving profiles, one of which acts on the first main belt drive and one of which acts on the second main belt drive. The advantage of this arrangement is that the auxiliary P.T.O. stub is thereby driven directly proceeding from the main pulley of the internal combustion engine. For the rest, in addition to the two intermediate drive stages in the main belt drive, a driven pulley for a transfer pump also is provided. This transfer pump is, inter alia, a component of a hydrostatic drive, which is used as the ground drive of the combine harvester or, within the framework of this ground drive, provides the hydrostatic power flow within a power-split transmission. Moreover, the transfer pump is used to drive working hydraulic components to which it is drivably connected via intermediate drive stages. The chaff spreader, for example, is driven by the transfer pump.

Furthermore, the device for the separation of residual grain is designed as a drum-type conveyor part extending in the longitudinal direction of the combine harvester, which is enclosed, at least in sections, by a hollow cylindrical separating housing, Related mechanisms for the separation of residual grain are found, for example, in DE 100 62 429 A1, DE 10 2005 046 005 A1 and DE 103 23 788 A1. The drum-type conveyor part is driven, via a bevel gear, by the driven gear provided to drive the mechanism for separating the residual grain. The grains or fruits remaining in the stalk crop after the threshing procedure are separated out via the hollow cylindrical separating grate and reach the return pan of the combine harvester. Instead of this embodiment of the device for separating out residual grain, a variant comprising swinging tray-type shakers also can be provided. Due to the design of the first main belt drive, variants having mechanisms for the separation of residual grain can be provided within one series of a type of combine harvester, which are designed either as a drum-type conveyor part or as a tray-type shaker.

In addition, the first belt drive and/or the second belt drive can be designed as variator transmissions. Therefore, the drive speeds of the mechanism for separating out of residual grain and/or the straw chopper can be steplessly adjusted, determined on a basis of the crop flow resulting from the stand density. Instead of the stepless adjustment, it also is possible to provide an adjustment that permits the corresponding drive speed to be steplessly changed. To this end, a compact planetary gear set or a belt-change stage may be a component of the particular drive arrangement.

In another embodiment, a third intermediate drive stage is driven proceeding from the second intermediate drive stage via a third belt drive, proceeding from which the front harvesting attachment is driven via a fourth belt drive. In addition, a pulley connected to a drive of a cleaning unit can be driven by the second intermediate drive shaft via a fifth belt drive. This driven pulley, which is connected to the cleaning unit, forms an assembly with a drive pulley, and therefore, the unit functions as a fourth intermediate drive stage, proceeding from which a grain-delivery auger and/or a conveyor auger for tailings and/or a grain elevator are driven via a sixth belt drive. The result thereof is a very compact arrangement of the directly adjacent second, third, and fourth intermediate drive stages, wherein, as explained above, the third intermediate drive stage simultaneously functions as the driven gear for driving the cleaning unit. Since the fourth belt drive for the driven pulley for the front harvesting attachment is guided by the third intermediate drive stage, the overall result is a highly ordered, transparent course of the belt, by which the number of components is considerably reduced as compared to previously known solutions.

Additionally, a variator drive for driving a threshing and separating mechanism and a seventh belt drive for driving a cleaning fan extend from the output-side end of the auxiliary P.T.O. stub. This part of the drive system is located on the side of the machine on the left as viewed in the direction of travel of the combine harvester. The threshing and separating device is designed as a tangential threshing drum and an adjoining straw impeller. The direction of rotation of the straw impeller can be reversed using a crossing-over drive belt. The threshing and separating device can be a multi-drum arrangement, for example, comprising an additional preacceleration drum and an additional separating cylinder.

### BRIEF DESCRIPTION OF THE DRAWINGS

Further features and advantages of the invention will become apparent from the description of embodiments that follows, with reference to the attached figures, wherein:

FIG. 1 presents a side view of a self-propelled combine harvester with a partial longitudinal sectional view through the threshing and separating mechanism, the cleaning unit and the device for separating out residual grain;

FIG. 2 is a schematic representation of a part of a drive system of the combine harvester of FIG. 1, wherein only a first and a second main belt drive are shown in order to clearly illustrate one arrangement according to the invention;

FIG. 3 is a schematic representation of the drive system according to FIG. 2, further including a drive of a third intermediate drive step,

FIG. 4 is a schematic representation of the drive systems according to FIGS. 2 and 3, highlighting that the belt drives are driven by an auxiliary P.T.O. stub and are provided on an opposite side of the combine harvester; and

FIG. 5 is a schematic representation of the drive systems according to FIGS. 2 and 3, additionally comprising a drive of a front harvesting attachment, a cleaning unit, a device for separating out residual grain and a drive of grain-delivery augers and grain elevators.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

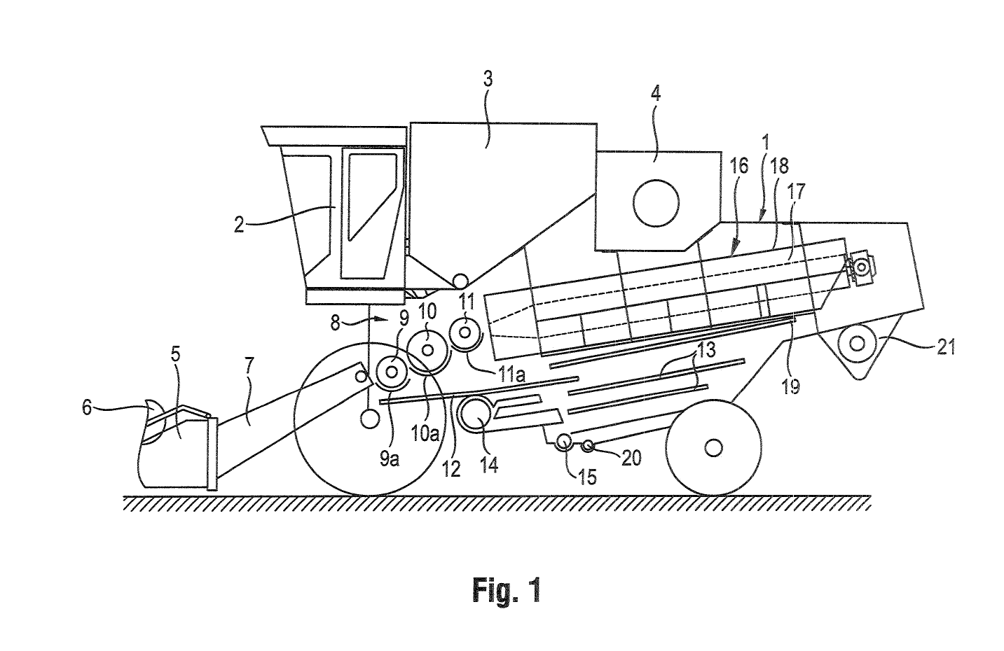

In FIG. 1, a self-propelled combine harvester is labelled with reference numeral 1 and comprises a driver's cab 2, a grain tank 3 disposed behind this driver's cab and, adjacent to this grain tank, an internal combustion engine 4. In addition, the self-propelled combine harvester 1 accommodates, in the front region thereof, a front harvesting attachment 5 (which is shown only in part) and is embodied as a grain and rapeseed header. A corn header also can be used as the front harvesting attachment 5, which captures the corn stalks and separates the corn cobs from the corn stalks by means of a snapping unit.

This front harvesting attachment 5 captures the stalk crop to be harvested using a reel 6 and severs the stalk crop close to the ground using a cutting mechanism. The cut crop is fed from the front harvesting attachment 5 to a threshing and separating mechanism 8 using a feed rake 7. This threshing and separating mechanism 8 is embodied as a multi-drum arrangement of a tangential threshing mechanism and comprises a preacceleration drum 9, a threshing drum 10, and a separating cylinder 11. Separating grates 9a, 10a, and 11a are associated with these drums 9, 10 and 11. The harvested kernels or fruits travel through the separating grates 9a, 10a and 11a and reach a grain pan 12, via which these kernels or fruits are fed to swinging sieves of a cleaning unit 13. A cleaning fan 14 cooperates with the cleaning unit 13. The cleaning fan generates an air flow in the region of the sieves, by which chaff and broken straw are moved out of the combine harvester 1. The kernels or fruits passing through the sieves of the cleaning unit 13 reach a grain-delivery auger 15, which transports these kernels or fruits to a non-illustrated grain elevator connected to the grain tank 3.

All portions of the stalk crop that do not pass through the separating grates 9a, 10a and 11a in the direction of the grain pan 12 and which comprise straw, broken straw, ears and, possibly, awns, are fed by the separating cylinder 11 or, by a straw impeller to a device 16 for separating out residual grain. The device 16 for separating out residual grain comprises (FIG. 1), a drum-type conveyor part 17 extending in the longitudinal direction of the combine harvester, which is also referred to as a separating rotor and comprises conveyor elements extending in a helical manner on the radial circumference thereof.

The drum-type conveyor part 17 is furthermore radially enclosed by a separating housing 18, which comprises separating openings in the lower region thereof and is closed, i.e. impermeable, in the upper region. Residual grain, chaff, ears and, possibly, broken straw pass through the aforementioned openings of the separating housing 18 and reach a return pan 19, which feeds these components to the cleaning unit 13. The components of this crop stream that are separated out by the sieves of the cleaning unit 13, such as non-threshed out ears, reach a conveyor auger 20, which feeds these components of the crop to tailings. The tailings conveys these components of the crop back into the threshing and separating device 8. The straw conveyed through the separating housing 18 exits this separating housing at the rear end thereof, where the straw enters a straw chopper 21.

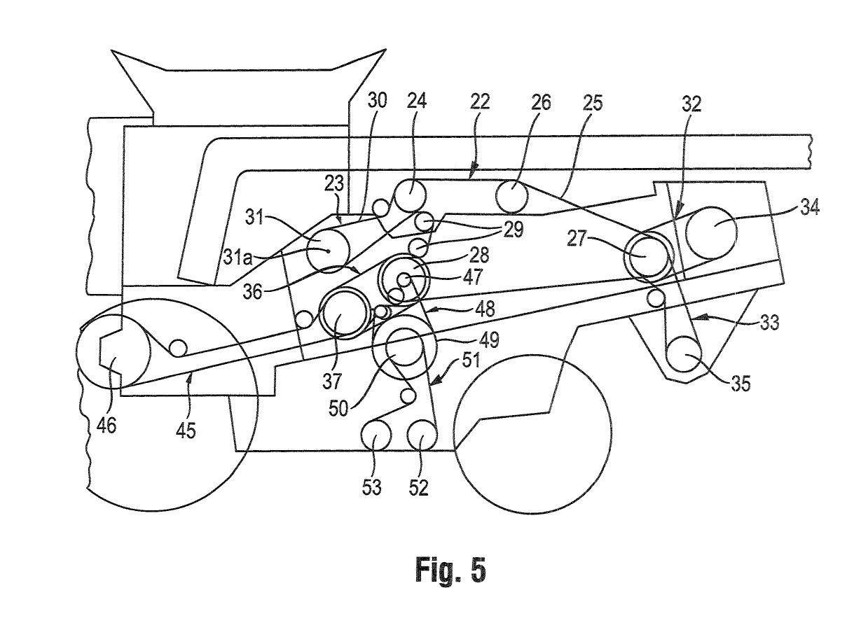

FIG. 5 (explained in detail further below), shows one embodiment of a drive system for a combine harvester 1 (FIG. 1), which is the part of the drive system located on the left side as viewed in the direction of travel of the combine harvester 1. FIG. 4 shows the part of the drive mechanism of the combine harvester 1 located on the right side of the combine harvester 1.

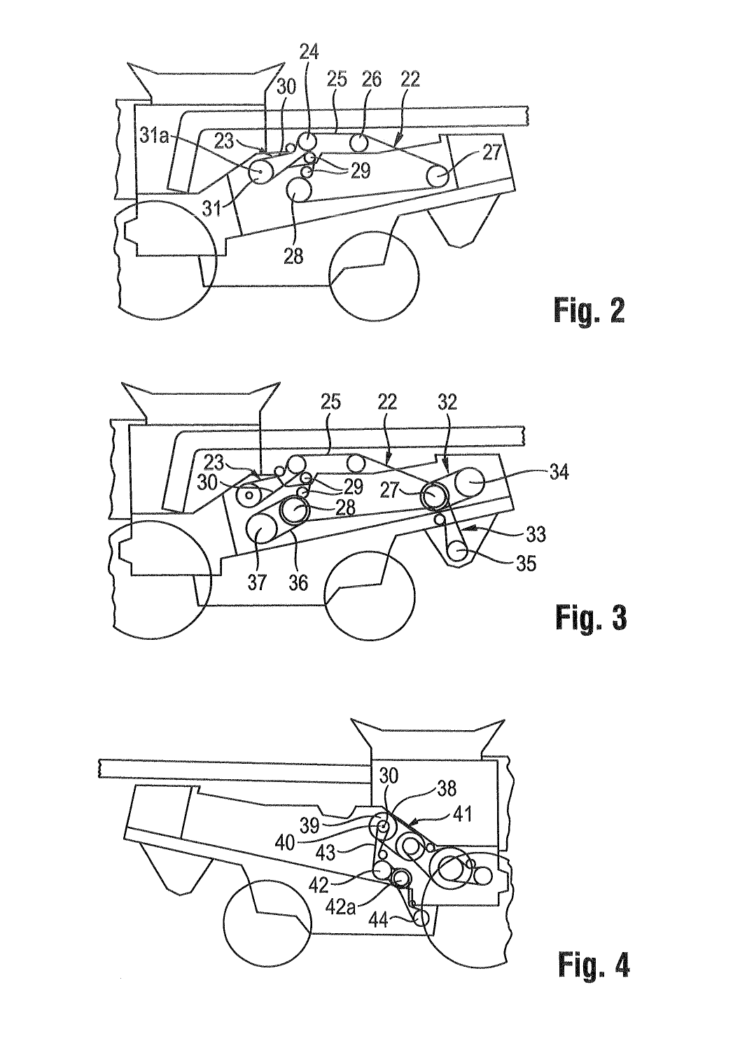

In order to further clarify the courses of the belts and the drive-related connection of the drive elements of the drive system, the representation according to FIG. 2 is limited to the basic design of this drive, which comprises a first main belt drive 22 and a second main belt drive 23. The first main belt drive 22 and the second main belt drive 23 are driven by a main drive pulley 24, which is set into rotation by the internal combustion engine 4. Since the main drive pulley 24 drives two different belt drives, namely the first main belt drive 22 and the second main belt drive 23, this main drive pulley is equipped with two different belt drive profiles, which can have the same diameter or different diameters.

The first main belt drive 22 comprises a first power band belt 25, which is guided via a driven pulley 26 of a transfer pump, a first intermediate drive stage 27, and a second intermediate drive stage 28. In addition, the first power band belt 25 is tensioned via a tensioning system 29. Furthermore, a second power band belt 30 extends from the main pulley 24 to a driven pulley 31 disposed on an auxiliary P.T.O. stub 31a. The function of this auxiliary P.T.O. stub 31a will be addressed in association with FIG. 4.

FIG. 2 shows that the first power band belt 25 is engaged with the first intermediate drive stage 27, which is provided to drive the device 16 for separating out residual grain and the straw chopper 21 (as will be explained in greater detail below), and with the second intermediate drive stage 28. The second intermediate drive stage 28 is used to drive the front harvesting attachment 5 and the cleaning unit 13. Since all the drive torque is not transmitted by the main drive pulley 24 via a first power band belt 25 to a single pair of pulleys, but rather to the two intermediate drive stages 27 and 28, the power band belt 25 is designed having a relatively narrow belt width. In addition, the overall result thereof is a relatively simple basic design of the drive system, which functions using a relatively small number of components.

According to FIG. 3, the drive system additionally includes only the aforementioned drive for the device 16 for separating out residual grain, the straw chopper 21, the front harvesting attachment 5 and the cleaning unit 13. To this end, the first intermediate drive stage 27, which is rotatably disposed on the machine frame of the combine harvester 1, is connected to a section for the output of the first power band belt 25 and to sections for driving a first belt drive 32, which leads to the device 16 for separating out residual grain, and is connected to a second belt drive 33, which leads to the straw chopper 21.

The first belt drive 32 comprises a driven pulley 34 of the device 16 for separating out residual grain, while a driven pulley 35 connected to the straw chopper 21 is a component of the second belt drive 33. A third belt drive 36 extends from the second intermediate drive stage 28 to a third intermediate drive stage 37, which, similarly to the first and second intermediate drive stage 27 and 28, respectively, form an interconnection of pulleys that are non-rotatably interconnected and are rotatably mounted on the machine frame of the combine harvester 1. The arrangement according to Fig. is completed to form an overall arrangement of the drive system provided on the left machine side of the combine harvester 1, as shown in FIG. 5.

FIG. 4 shows the side of the machine on the right as viewed in the direction of travel of the combine harvester 1. According thereto, the auxiliary P.T.O. stub explained above in association with FIGS. 2 and 3 drives a driven pulley 38, which is integrally formed with drive pulleys 39 and 40. The drive pulley 39 is a component of the variator drive 41, which drives the separating cylinder 11, the threshing drum 10, and the preacceleration drum 9. A seventh belt drive 43 proceeds from the drive pulley 39 to a pulley 42, which is drivably connected to a pulley 42a. The latter drives a driven pulley 44 provided for the cleaning fan 14.

FIG. 5 shows the essential components of the drive system provided on the left machine side of the combine harvester 1. In addition to the arrangement according to FIG. 3, the third intermediate drive stage 37 drives, via a fourth belt drive 45, a driven pulley 46 connected to the front harvesting attachment 5. Moreover, a fifth belt drive 48 proceeds from an output 47 of the second intermediate drive stage 28 and is engaged with a driven pulley 49 connected to the cleaning unit 13. A drive pulley 50 proceeds from this driven pulley 49 and is connected via a sixth belt drive 51 to driven pulleys 52 and 53 for the grain-delivery auger 15 and the conveyor auger 20.

FIGS. 2 to 5 show a drive system having an optimal configuration of the first main belt drive 22 and the second main belt drive 23, which form the basis for an ordered design and the arrangement of the further belt drives. The result thereof provides an advantage that the first main belt drive 22, which accommodates the first intermediate drive stage 27 and the second intermediate drive stage 28 as driven elements, functions using a narrow power band belt 25. Due to this basic design, a systematic and ordered design results for the further belt drives proceeding from the two main belt drives 22 and 23, which has the advantage that components can be spared to a considerable extent as compared to known drive systems.

### LIST OF REFERENCE CHARACTERS

1 self-propelled combine harvester
2 driver's cab
3 grain tank
4 internal combustion engine
5 front harvesting attachment
6 reel
7 feed rake
8 threshing and separating mechanism
9 preacceleration drum
9a separating grate of 9
10 threshing drum
10a separating grate of 10
11 separating cylinder
11a separating grate of 11
12 grain pan
13 cleaning unit
14 cleaning fan
15 grain-delivery auger
16 device for separating out residual grain
17 drum-type conveyor part
18 separating housing
19 return pan
20 conveyor auger
21 straw chopper
22 first main belt drive
23 second main belt drive
24 main drive pulley
25 first power band belt of 22
26 driven pulley of a transfer pump
27 first intermediate drive stage
28 second intermediate drive stage
29 tensioning system of 25
30 second power band belt
31 driven pulley of 31a auxiliary P.T.O stub
31a first belt drive for 16
32 second belt drive for 21
33 driven pulley of 16
34 driven pulley of 21
35 third belt drive
36 third intermediate drive stage
37 driven pulley of 30
38 drive pulley of 38
39 drive pulley
40 variator drive
41 pulley
42 pulley
42a seventh belt drive
43 driven pulley of 14
44 fourth belt drive
45 driven pulley of 5
46 output of 48
47 fifth belt drive
48 driven pulley for 13
49 driven pulley for 15
50 sixth belt drive
51 driven pulley for 15
52 driven pulley for 20
53 driven pulley for 20

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A drive system, embodied as belt drives, of a self-propelled combine harvester, comprising:
a main drive pulley arranged on one machine side of the combine harvester and driven by an internal combustion engine; and
a device for separating out residual grain and a straw chopper proceed from main drive pulley and are driven via a first intermediate drive stage;
wherein the main drive pulley, the first intermediate drive stage and a second intermediate drive stage are components of a first main belt drive;
wherein the first intermediate drive stage directly drives the device for separating out residual grain via a first belt drive and drives the straw chopper via a second belt drive; and
wherein the second intermediate drive stage is drivably connected to respective drives of a front harvesting attachment and a cleaning unit.

2. The drive system of claim 1, wherein the main drive pulley is connected via a second main belt drive to an auxiliary P.T.O. stub leading to an opposite machine side and wherein the auxiliary PTO drives belt drives on the opposite machine side.

3. The drive system of claim 1, wherein the device for separating out residual grain is designed as a drum-type conveyor part that extends in a longitudinal direction of the combine harvester and is enclosed, at least in sections, by a hollow cylindrical separating housing.

4. The drive system of claim 1, wherein the device for separating out residual grain is designed as a plurality of tray-type shakers driven via crank drives.

5. The drive system of claim 1, wherein a driven pulley of a transfer pump of a hydrostatic drive is disposed within the first main belt drive.

6. The drive system of claim 1, wherein the first belt drive, the second belt drive or both are designed as variator drives.

7. The drive system of claim 1, wherein the second intermediate drive stage drives, via a third belt drive, a third intermediate drive stage and wherein the front harvesting attachment is driven via a fourth belt drive proceeding from the third intermediate drive stage.

8. The drive system of claim 1, wherein the second intermediate drive stage drives, via a fifth belt drive a driven pulley connected to a drive of a cleaning unit.

9. The drive system of claim 8, wherein the driven pulley connected to the drive of the cleaning unit is non-rotatably connected to a drive pulley for a sixth belt drive, wherein the sixth belt drive is provided to drive at least one of a group of driven units consisting of a grain-delivery auger, a conveyor auger, a grain elevator and tailings.

10. The drive system embodied of claim 2, wherein a variator drive for driving a threshing and separating mechanism and a seventh belt drive for driving a cleaning fan extend from the output-side end of the auxiliary P.T.O. stub.
